(19) United States
(12) Patent Application Publication
(10) Pub. No.: US 2012/0208066 A1
(43) Pub. Date: Aug. 16, 2012

(54) METHOD FOR THE PRODUCTION OF AN ELECTRODE STACK

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/390,548

(22) PCT Filed: Jul. 29, 2010
(86) PCT No.: PCT/EP2010/004648

§ 371 Date: Apr. 30, 2012

(30) Foreign Application Priority Data
Aug. 17, 2009 (DE) 10 2009 037 727.1

(51) Int. Cl. H01M 10/04; H01M 4/505; H01M 10/0583; H01M 4/485; H01M 4/52; H01M 2/14; H01M 2/16; H01M 4/525

(52) U.S. Cl. 429/131; 429/144; 429/246; 429/224; 429/223; 429/231.1; 429/221; 29/623.1; 29/623.5

(57) ABSTRACT

A method for producing an electrode stack (1) comprising three or more layers for an electrochemical energy storage device is disclosed. The electrode stack (1) has one or more separator layers (2, 2a, 2b) and two or more electrode plates (3, 3a, 4, 4a). Each of the electrode plates (3, 3a, 4, 4a) has a first polarity or a second polarity.

The present invention relates to a method for producing an electrode stack, an electrode stack produced with this method, an electrochemical energy storage apparatus with at least one of these electrode stacks and a battery with at least one of these electrochemical energy storage apparatuses. The invention is described in connection with lithium-ion batteries. The invention can also be used independently of the design of the battery.

Electrochemical energy storage apparatuses are known from the prior art, the actual charge capacity of which already falls below the computational charge capacity after production. Furthermore, electrochemical energy storage apparatuses are known, the charge capacity of which decreases during operation.

A flat cell of the type mentioned at the beginning is known from DE 199 43 961 A1, in which the separator has a larger area than the cathode and the anode. The known flat cell has housing parts, into which the cathode and/or the anode are introduced. The housing parts are connected to one another by means of a closure material, in order to finish the cell.

It is the object of the invention, to provide an electrode stack for an electrochemical energy storage apparatus, the computational charge capacity of which is substantially maintained even during the operation of the electrode stack or an associated electrochemical energy storage apparatus.

This is achieved according to the invention by means of the teaching of the independent claims. Developments of the invention which are to be preferred are the subject of the subclaims. Claim 9 describes an electrode stack which is produced with a method according to the invention. Claim 12 describes an electrochemical energy storage apparatus with at least one of these electrode stacks. Claim 13 describes a battery with at least one electrochemical energy storage apparatus with an electrode stack according to the invention.

A method according to the invention performs the production of an electrode stack with three or a plurality of layers for an electrochemical energy storage apparatus. The electrode stack has one or a plurality of separator layers. Further, the electrode stack has two or a plurality of electrode plates with a first polarity or a second polarity in each case. According to the invention, a separator layer is arranged by means of a guiding apparatus, in particular on an electrode plate. An electrode plate of the first polarity is in particular arranged on the separator layer. One layer of the electrode stack, in particular this electrode plate of first polarity is fixed by means of a first holding apparatus. Preferably, the individual steps take place in the mentioned or alphabetical order according to Claim 1c, particularly preferably also repeatedly one after the other.

In the sense of the present invention, an electrode stack is understood as meaning a device which is used in particular for accepting and emitting energy. To this end, the electrode stack has at least three layers, including at least one electrode of a first polarity, an electrode of a second polarity and also a separator arranged between these electrodes. Preferably the layers of the electrode stack are of thin-walled construction. Particularly preferably, the individual layers of the electrode stack are of rectangular construction. One layer of the electrode stack is preferably constructed as an electrode plate or separator layer. The electrode stack extends in a main stacking direction which is perpendicular to the surfaces of a layer which touch adjacent layers.

In the sense of the invention, an electrode plate is understood as meaning an apparatus which is used for emitting and/or accepting in particular electrical energy. Electrical energy fed to an electrode plate is initially converted into chemical energy and stored as chemical energy. Preferably, ions are temporarily fed to an electrode plate which are deposited on interstices. Before emitting electrical energy, in an electrode plate, the stored chemical energy is initially converted into electrical energy. Also, an electrode plate is provided, to temporarily accept and/or emit electrons. Preferably, an electrode plate is of thin-walled and essentially rectangular construction, the electrode plate having four boundary edges.

In the sense of the invention, a separator or a separator layer is understood as meaning an apparatus which spaces in particular two electrode plates from one another. Preferably, one separator layer spaces two electrode plates of different polarity. Preferably, one separator layer temporarily accommodates an electrolyte. Particularly preferably, one separator layer at least temporarily accommodates lithium ions. Preferably, a separator layer essentially acts as an insulator with respect to electrons. Preferably, a separator layer is of thin-walled and plate-shaped construction. Preferably, the geometry of a separator layer corresponds to the shape of an adjacent electrode plate. Particularly preferably, the lengths of the boundary edges of a separator layer are longer than the corresponding, in particular parallel running boundary edges of adjacent electrode plates.

In the sense of the invention, the polarity of an electrode plate is understood as meaning that this electrode plate is electrically connected either to the positive pole or the negative pole of an electric voltage source superordinate to the electrode stack. An electrode plate is in this case either connected to the positive pole or the negative pole of the superordinate voltage source and has either a first or a second polarity. An electrode plate of first polarity is preferably constructed as an anode, an electrode plate of second polarity is preferably constructed as a cathode. In this case, the term “anode” designates the electrode which is negatively charged in the charged state.

In the sense of the invention, arrange is understood as meaning a procedure whereby a separator layer or an electrode plate is supplied to the superordinate electrode stack. Preferably, a separator layer or an electrode plate is supplied to the electrode stack in such a manner that the boundary edges of the individual layers are arranged essentially parallel to one another. Preferably, a separator layer or an electrode plate is supplied to the electrode stack in such a manner that the supplied layer contacts the adjacent layer essentially over the entire surface.

In the sense of the invention, a guiding apparatus is understood as meaning an apparatus which temporarily holds a layer to be supplied to the electrode stack in a positive or non-positive manner, supplies this layer at the electrode stack and arranges the same on a layer of the electrode stack. The guiding apparatus is provided to release a layer following the arrangement thereof in the electrode stack. Preferably, a guiding apparatus is constructed as a gripping apparatus. Preferably, a guiding apparatus is automated, particularly for increasing the repeat accuracy. Preferably, a guiding apparatus is computer controlled. Preferably, a guiding apparatus has a pair of rollers or rolls, between which a separator layer is temporarily located. Particularly preferably, the spacing of the roller pair is variable.

In the sense of the invention, fixing is understood as meaning that the inadvertent displacement of the electrode stack or one of the layers thereof can only take place after overcoming a resistance. The fixing in particular means that an automated guiding apparatus or feeding apparatus can supply a separator layer to the electrode stack in an orderly manner. Particularly if the recently supplied layer, relatively to the electrode stack, or the electrode stack as a whole is not located in its predetermined position, there is a risk that a layer to be supplied protrudes out of the electrode stack at least to some extent. With the fixing of a layer or the electrode stack, the maintenance of the predetermined positions of the individual layers in particular is improved.

In the sense of the invention, a holding apparatus is understood as meaning an apparatus which is used in particular for fixing a layer of the stack or the entire stack. Preferably, the holding apparatus temporarily exerts a force onto a layer of the electrode stack or the entire electrode stack. Preferably, the holding apparatus is automated. Preferably, the holding apparatus is provided for interacting with the guiding apparatus. Preferably, the holding apparatus is adapted to the shape of a layer of the electrode stack. Preferably, the holding apparatus is configured in such a manner that the force acting on a layer of the electrode stack during a fixing process is adapted to the surface pressure which this layer can endure. Preferably, the holding apparatus is provided to fix an electrode plate. Preferably, the holding apparatus is provided to temporarily exert a force onto an electrode plate. Preferably, the width of a holding apparatus is adapted to the width of a layer of the electrode stack, particularly to an electrode plate.

With the production of an electrode stack according to the method according to the invention, the relative positioning of a second layer of the electrode stack to a first layer, particularly the parallelism of the boundary edges of the layers of the electrode stack and the essentially full-surface mutual covering of adjacent layers, is improved. With the production according to the invention, it is in particular avoided that an electrode plate extends at least to some extent beyond the adjacent separator layers. The so-called creeping distance, i.e. the spacing between the live parts, is extended in that one separator layer preferably extends over adjacent electrode plates. In this manner, particularly electric currents between the boundary edges of two electrode plates of different polarity, so-called parasitic currents, are reduced by the separator layer lying therebetween. Currents between boundary edges of electrode plates of different polarity in particular lead to a reduction of the energy stored in the electrode stack.

Currents between the boundary edges of electrode plates of different polarity in particular lead to local heating and progressive ageing of the affected areas.

Thus, with the production of an electrode stack according to the method according to the invention, the capacity to store energy thereof is improved, the stored energy is to a large extent retained, the ageing of the electrode plates is reduced and the underlying object is achieved.

Thus, the leakage of the contents of a galvanic cell is prevented and the underlying object is achieved.

The developments of the invention which are to be preferred are described in the following.

The method is advantageously used for producing the electrode stack with in particular five or more layers. To this end, the production process has further steps which are carried out in addition to the previously mentioned steps. Thus, a separator layer is in particular arranged on one of these electrode plates by means of the guiding apparatus. Furthermore, an electrode plate of second polarity is arranged in particular on the separator layer. Further, one layer of the electrode stack, in particular the electrode plate of second polarity is fixed by means of a second holding apparatus. Furthermore, the first or second holding apparatus is removed from the electrode stack. Preferably, the holding apparatus, which is located between two layers in the interior of the electrode stack, is removed. Preferably, the steps d) to g) are carried out in alphabetical order and following step c). Preferably, one of the two holding apparatuses is only removed if the other of the two holding apparatuses fixes a layer of the electrode stack. Preferably, during the production of the electrode stack both holding apparatuses are repeatedly simultaneously involved with the fixing. Preferably, during the production of the electrode stack and following the arrangement of the first electrode plate always at least one holding apparatus is involved with the fixing of a layer of the electrode stack. Advantageously, the maintenance of the position of the electrode stack or the fixed layer of the electrode stack is performed in this manner during the production of the electrode stack. Preferably, one or both of these first or second holding apparatuses temporarily exert a normal force at least onto one of the electrode plates in each case, the normal force acting perpendicularly on a surface of one of the electrode plates.

Preferably, only a first electrode plate of first polarity, followed by a separator layer, followed by an electrode plate of second polarity, followed by a further separator layer are arranged in the electrode stack. In this manner, a sequence of separator layer—electrode plate of first polarity—separator layer—electrode plate of second polarity results in the electrode stack.

A3 Advantageously, the guiding apparatus exerts a pulling force on the separator layer at least during the steps a) and d). Thus, the risk of the formation of folds in the arrangement of a separator layer and/or the inclusion of air between a separator layer and an adjacent electrode plate is reduced. Furthermore, this pulling force is used in particular to improve the contacting of the separator layer and the adjacent electrode plate, which to the greatest possible extent takes place over the entire surface. Preferably, the pulling force exerted on the separator layer by the guiding apparatus is dimensioned in such a manner that, insofar as it is possible, the separator layer is not strained.

A4 Advantageously, during steps b) or e), this one or plurality of electrode plates are supplied to the electrode stack with a direction vector which runs parallel to a layer of the electrode stack. Preferably, this one or plurality electrode plates are supplied from the side with a direction vector which is arranged perpendicularly to the main stacking direction of the electrode stack. Preferably, this one or plurality of electrode plates are supplied from the side. Preferably, electrode plates of different polarity are guided to the electrode stack from various sides. Preferably, the electrode stack is displaced by a predetermined distance along the main stacking direction following the supplying of a layer and before the supplying of the next layer. Thus, the supplying of the next layer can advantageously take place along the same motion vector. Preferably, during the displacement of the electrode stack along its main stacking direction as it were, the holding apparatuses are also displaced. Thus, a holding apparatus, in particular also during the displacement of the electrode stack, can also exert a force onto a layer, in particular an electrode plate. If the production of an electrode stack takes place with the aid of an accommodation apparatus, especially with a table, this accommodation apparatus is preferably height-adjustable. After the arrangement of a layer of the electrode stack, the accommodation apparatus is displaced by a predetermined distance, especially lowered. Particularly preferably, this predetermined distance corresponds to the wall thickness of the recently supplied separator layer. Preferably, this one or both holding apparatuses are assigned to the same accommodation apparatus. Particularly preferably, this one or both holding apparatuses are connected to the same accommodation apparatus.

A5 Advantageously, during steps a) and/or d), the separator layer is arranged by means of the deflection of the previously placed separator layer by means of the guiding apparatus. In this case, the separator layer does not end in the vicinity of a boundary edge of the adjacent electrode plate, but extends significantly beyond this boundary edge, the separator layer essentially being dimensioned at least twice as large as an adjacent electrode plate. In this case, the separator material forming the separator layer is constructed in a strip-like manner, the surface of the separator material being dimensioned at least as large as twice the surface of an electrode plate. The separator material extends in a strip-like manner along a main extension direction and has a predetermined width. This predetermined width essentially corresponds to the length or width of the adjacent, essentially in particular rectangular electrode plate. The separator material has a plurality of essentially rectangular separator regions which are provided, in each case to act as a separator layer. The separator material is preferably supplied to the electrode stack in such a manner that a first separator region forms a first separator layer and an adjacent second separator region forms a second separator layer. These first and second separator regions border one another along a deflection region. This deflection region protrudes between two adjacent electrode plates and adjoins an adjacent electrode plate essentially along a boundary edge thereof. In the sense of the invention, deflecting the previously arranged separator layer is understood as meaning that the strip-shaped separator material is angled out of the plane of the previously arranged separator layer and is brought to adjoin the still exposed surface of the adjacently arranged electrode plate at the boundary edge of the same electrode plate. Preferably, the strip-like separator material is only separated after the finishing of the electrode stack. Preferably, during the deflection, the guiding apparatus exerts a pulling force on the separator layer or the separator material. Whilst this puling force is exerted, the first or the second holding apparatus exerts a normal force on the previously arranged electrode plate. Thus, an undesired displacement of a layer of the electrode stack is prevented in particular. Preferably, the separator layer or the separator material is deflected around this first or second holding apparatus. In this case, this first or second holding apparatus closes substantially flush with the boundary edge of the previously arranged electrode plate facing the deflection region of the separator material.

A6 Advantageously, a first fluid flow is fed to the separator layer or the separator material before or during the arrangement thereof in the electrode stack. Preferably, the first fluid flow flows along the separator layer or the separator material. Preferably, this fluid flow is used for the vaporising of a solvent, the supplying of a solvent and/or the supply of heat energy. Particularly preferably, the fluid flow is loaded with an electrolyte. Preferably, this electrolyte has lithium ions. Preferably, the fluid flow has a solvent, a gas of predetermined temperature and/or particles. Preferably, the fluid flow is constructed as a charged solvent mist which is directed with a predetermined essentially right angle onto a surface of the separator material or the separator layer.

A7 Advantageously, a separator layer is unwound from a first supply apparatus and supplied to the electrode stack. In the sense of the invention, a first supply apparatus is understood as meaning an apparatus by which the separator material is accommodated and can be discharged. The guiding apparatus is arranged between the electrode stack and the first supply apparatus along the separator material. Preferably, the first supply apparatus has a drive which is in particular used together with the guiding apparatus to limit the pulling force on the separator layer or the separator material. Preferably, the drives of the guiding apparatus and the first supply apparatus are coupled. Preferably, a separating apparatus is assigned to the first supply apparatus or the guiding apparatus. The same is provided to in particular cut off the separator material after the finishing of an electrode stack.

A8 Advantageously, an electrode plate is removed from a second supply apparatus before or during the arrangement thereof in the electrode stack, in particular unwound and in particular separated by means of a separation apparatus. In the sense of the invention, a second supply apparatus is understood as meaning a supply apparatus corresponding to a first supply apparatus, whereby a second supply apparatus is provided however to accommodate and deposit electrode material. Preferably the separation of an electrode plate takes place before the arrangement thereof in the electrode stack by means of a separating apparatus which separates individual electrode plates from the electrode material.

Preferably, separated electrode plates are kept ready for supplying on a storage area as a stack. Preferably, this storage area is height adjustable in stacking apparatuses. Preferably, the storage area is raised by a predetermined distance following the removal of an electrode plate. Preferably, this predetermined distance corresponds to the wall thickness of the electrode plate. Preferably, this storage area is lowered by this predetermined distance before the supplying of an electrode plate.

Preferably, the depositing of the materials for the electrode plates of different polarities takes place from two different second supply apparatuses.

Preferably, an electrode stack produced according to the invention is transferred to a drying apparatus which removes solvent from the electrode stack. Preferably, an electrode stack is transferred to a jacket following its production.

A9 Advantageously, an electrode stack produced in accordance with a method according to the invention has five or a plurality of essentially rectangular layers. Two or more separator layers are included. These two or plurality of separator layers are arranged between two electrode plates of different polarity in each case. The electrode stack is characterised in that these two or plurality of separator layers extend in certain areas over adjacent electrode plates in each case. Preferably, these two or plurality of separator layers extend circumferentially over adjacent electrode plates in each case. This serves in particular to lengthen the creeping distances and thus to reduce electric currents between boundary edges of electrode plates of different polarity. The fact that a separator layer extends circumferentially over adjacent electrode plates of different polarity means that the insulation distance between these adjacent electrode plates is increased. Thus, electric currents between these adjacent electrode plates are reduced. Further, the electrode stack is characterised in that these two or plurality of separator layers are constructed integrally. These two or plurality of separator layers are connected by means of a deflection region. A deflection region essentially extends along the entire length of a boundary edge of the electrode plate encompassed by the same separator layers. No leakage currents can be exchanged with this completely encompassed boundary edge. Preferably, these two or plurality of separator layers extend in certain areas by 0.01 mm to 10 mm, preferably by 1 mm to 3 mm at least over an adjacent electrode plate. Particularly preferably, these two or plurality of separator layers extend circumferentially over the adjacent electrode plates in each case.

A10 According to the invention, preferably, a separator or one or a plurality of separator layers are used, which is/are not or only poorly electron conductive and which consist(s) of a substrate which is at least partially permeable to material. The substrate is preferably coated on at least one side with an inorganic material. Preferably an organic material, which is preferably configured as a non-woven fleece, is used as a substrate which is at least partially permeable to material. The organic material, which preferably comprises a polymer and particularly preferably a polyethylene terephthalate (PET), is coated with an inorganic, preferably ion-conducting material which is further preferably ion-conducting in a temperature range from −40° C. to 200° C. The inorganic material preferably comprises at least one compound from the group of oxides, phosphates, sulphates, titanates, silicates, aluminosilicates with at least one of the elements Zr, Al, Li, particularly preferably zirconium oxide. Preferably, the inorganic ion-conducting material has particles with a largest diameter below 100 nm. A separator of this type is sold in Germany by Evonik AG under the brand name “Separion”, for example.

All Preferably, at least one electrode of the electrode stack, particularly preferably at least one cathode, has a compound with the formula LiMPO₄, where M is at least one transition metal cation of the first row of the periodic table of the elements. The transition metal cation is preferably chosen from the group consisting of Mn, Fe, Ni and Ti or a combination of these elements. The compound preferably has an olivine structure, preferably superordinate olivine.

A12 Advantageously, an electrochemical energy storage apparatus according to the invention has one or a plurality of electrode stacks which are produced with a method according to the invention. Further, an electrochemical energy storage apparatus according to the invention has a jacket. This is provided to surround this one or plurality of electrode stacks. Preferably, the jacket is provided to tension the layers of an electrode stack according to the invention with respect to one another. Preferably, the jacket exerts a normal force on the surfaces of the various layers of an electrode stack according to the invention and forces these layers against one another. Preferably, the jacket is constructed as a composite film.

A13 Advantageously, a battery has two or a plurality of electrochemical energy storage apparatuses with one or a plurality of electrode stacks which are produced with a method according to the invention. Preferably, this plurality of electrochemical energy storage apparatuses are connected amongst one another by means of series connection and/or parallel connection.

Further advantages, features and application possibilities of the present invention result from the following description in connection with the figures. In the figures:

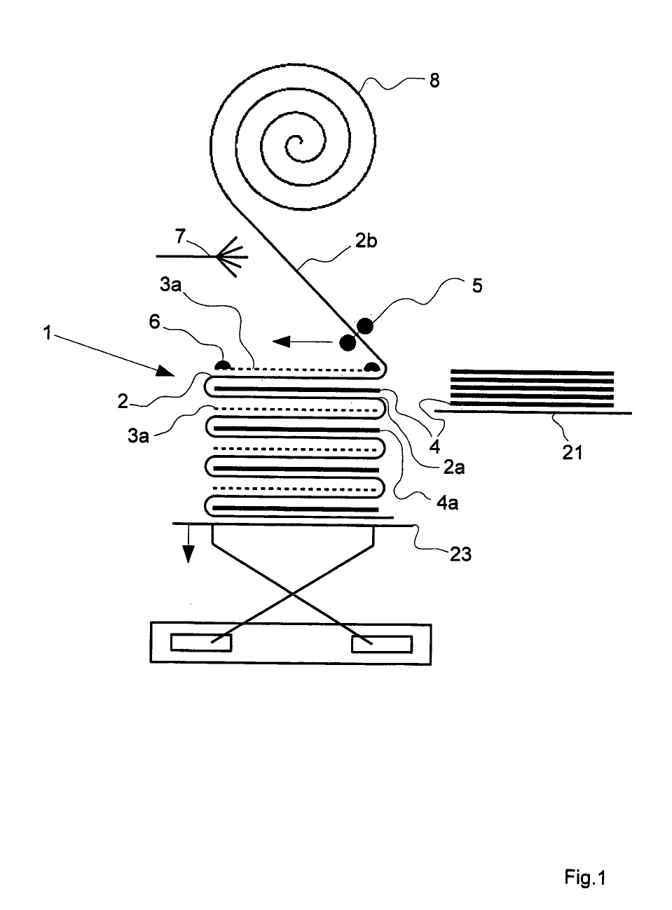

FIG. 1 schematically shows a method according to the invention for producing an electrode stack at a first time,

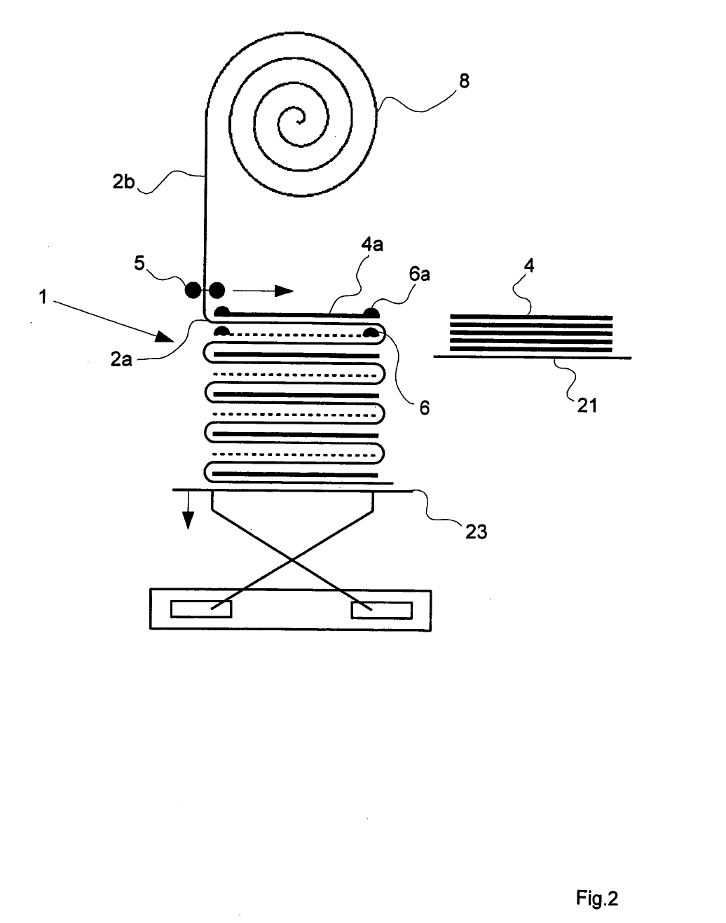

FIG. 2 schematically shows the state of the method from FIG. 1 at a later time, and

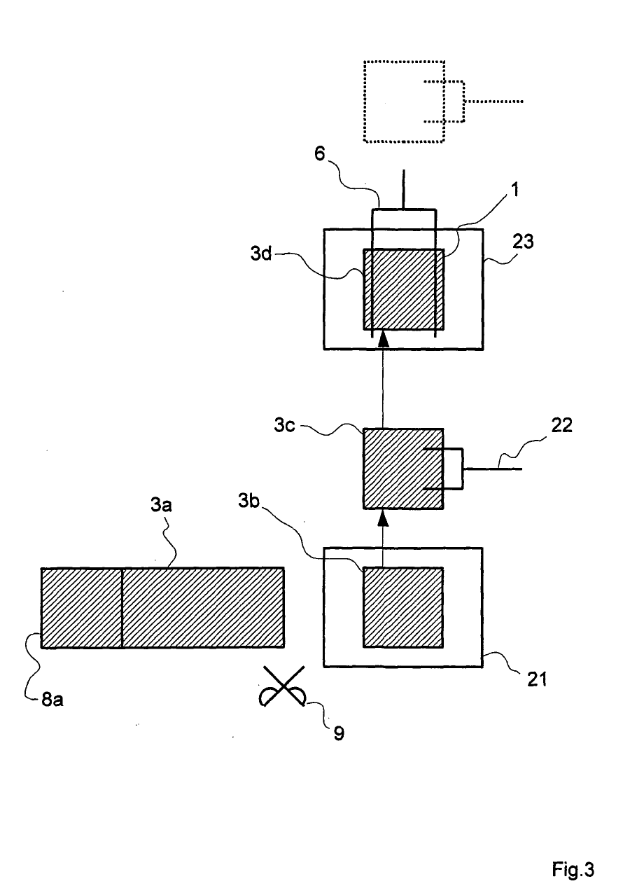

FIG. 3 schematically shows the production of an electrode stack according to a further method according to the invention.

FIG. 1 schematically shows the production of an electrode stack according to a method according to the invention. The electrode stack and the remaining apparatuses are illustrated ignoring actual measurements and spacings. The method is shown at a first time.

An electrode stack 1 is illustrated, which is produced on a lifting table 23. The electrode stack 1 has a plurality of separator layers 2, 2a, a plurality of electrodes 3, 3a of first polarity and also a plurality of electrodes 4, 4a of second polarity.

Electrode plates 4, 4a of second polarity are kept ready for supply on the storage area 21 and supplied to the electrode stack 1 by means of a feeding apparatus which is not illustrated. The provision of the electrode plates 3, 3a of second polarity is not illustrated. The separator material 2b is unwound from the separator roll 8a and supplied by means of the guiding apparatus 5 to the electrode stack 1 using guide rolls. The last supplied separator layer 2 is covered by an electrode plate 3 of first polarity. This electrode plate 3 is loaded with a force which is exerted by the first holding apparatus 6.

In the state illustrated, the step of fixing a layer of the electrode stack 1, particularly of the electrode plate 3 is executed by means of a holding apparatus 6. The guiding apparatus 5 has recently begun to arrange the separator layer 2 on the electrode plate 3. After the guide rolls of the guiding apparatus 5 have rolled a predetermined distance along the separator material, the rolls are locked or the spacing thereof from one another is reduced. Subsequently, the guiding apparatus 5 places the next separator layer 2b. In this case, the guiding apparatus 5 exerts a pulling force on the next separator layer or the separator material 2b. The hold-down device 6 prevents this pulling force from dismantling the electrode stack 1. The unwinding of the future separator layer 2b from the separator roll 8a takes place with adjustment of the movement thereof to the movement of the guide rolls 5. Before reaching the guiding apparatus 5, the separator material 2b is sprayed with an electrolyte mist 7.

FIG. 2 shows the method from FIG. 1 at a later time. Directly prior to that, the electrode plate 4a of second polarity was arranged on the electrode stack 1. Presently, a normal force is exerted on the electrode plate 4a by means of the second holding apparatus 6a. In a next step, the guiding apparatus 5 will arrange the next separator layer 2b on the electrode stack. In this case, the separator layer 2b is deflected from the separator layer 2a. Subsequently, the first holding apparatus 6 is pulled out of the electrode stack. To arrange the electrode plate 4a, the lifting table 23 was lowered by a distance corresponding essentially to the summed wall thicknesses of the separator layer 2a and the electrode plate 4a.

FIG. 3 schematically shows the arrangement of the electrode plates, here 3d in the electrode stack 1, which is stacked on the lifting table 23. Not illustrated are the supplying of the electrode plates of second polarity and the supplying of the separator layers. It is expedient and inventive to provide the supplying of the electrode plates of second polarity from the other side of the electrode stack (see dashed electrode plate plus gripper).

To supply the electrode plates of first polarity, the plate material 3a is unwound from the electrode roll 8a. The separated electrode plate 3b on the height adjustable storage area 21 is created by means of the separating shears 9. The gripper 22 supplies an electrode plate 3c to the lifting table 23 or the electrode stack 1. The heights of the storage area 21 and the table 23 are advantageously chosen in such a manner that the path of the gripper 22 does not have a component in the main stacking direction of the electrode stack 1. The hold-down device 6 presently exerts a force perpendicularly to the surface of the electrode plate 3d in the direction of the surface of the lifting table 23.

After the removal of the electrode plate 3b from the storage surface 21, the same is lifted in accordance with the wall thickness of the electrode plate 3b. After the placing of the electrode plate 3d, the lifting table 23 is lowered in accordance with the wall thickness of the electrode plate 3d.

The movements of the apparatuses 8a, 9, 21, 22, 6 and 23 are controlled by a superordinate control.

1-13. (canceled)

14. A method for producing an electrode stack (1) with three or a plurality of layers for an electrochemical energy storage apparatus, wherein the electrode stack (1) has one or a plurality of separator layers (2, 2a, 2b) and also two or a plurality of electrode plates (3, 3a, 4, 4a),
wherein two electrode plates (3, 3a, 4, 4a) separated by a separator layer have opposite polarities in each case, with the steps:
a) arranging a separator layer (2, 2a, 2b) on a first electrode plate (3, 3a, 4, 4a) by means of a guiding apparatus (5),
b) arranging a second electrode plate (3, 3a) on the separator layer (2, 2a, 2b), wherein the second electrode plate has an opposite polarity to the polarity of the first electrode plate,
c) fixing of the second electrode plate (3, 3a) by means of a first holding apparatus (6), wherein
d) the first holding apparatus at least temporarily exerts a force onto at least one layer of the electrode stack, and
e) the first holding apparatus is constructed in such a manner that this force is adapted to the surface pressure which the at least one layer can endure.

15. The method according to claim 14, further comprising the steps of:
f) arranging a separator layer (2, 2a, 2b) on one of electrode plates (3, 3a, 4, 4a) by means of the guiding apparatus,
g) arranging a third electrode plate (4, 4a) on the separator layer (2, 2a, 2b),
h) fixing of the third electrode plate (4, 4a) by means of a second holding apparatus (6a), and
i) removing the first or second holding apparatus (6, 6a) from the electrode stack (1).

16. The method according to claim 15, wherein the second holding apparatus at least temporarily exerts a force onto at least one layer of the electrode stack and the second holding apparatus is constructed in such a manner that the force is adapted to the surface pressure which the at least one layer can endure.

17. The method according to claim 16, wherein the guiding apparatus (5) exerts a pulling force on the separator layer (2, 2a, 2b) at least during the steps a) and d).

18. The method according to claim 17, wherein, during steps b) or e), the one or a plurality of electrode plates (3, 3a, 4, 4a) are supplied with a direction vector which runs parallel to a layer of the electrode stack (1).

19. The method according to claim 18, wherein, during steps a) or d), the separator layer (2, 2a, 2b) is arranged by means of the deflection of the previously arranged separator layer (2, 2a, 2b) by means of the guiding apparatus (5), wherein, the guiding apparatus (5) exerts a pulling force on the separator layer (2, 2a, 2b).

20. The method according to claim 19, wherein a first fluid flow, with an electrolyte, is fed to the separator layer (2, 2a, 2b) before or during the arrangement thereof in the electrode stack (1).

21. The method according to claim 20, wherein a separator layer (2, 2a, 2b) for the production of the electrode stack (1) is unwound from a first supply apparatus (8) and supplied.

22. The method according to claim 21, wherein an electrode plate (3, 3a, 4, 4a) is unwound from a second supply apparatus (8a) for the arrangement thereof in the electrode stack (1), supplied and separated by means of a separation apparatus (9).

23. An electrode stack (1) produced according to the method according to claim 14.

24. The electrode stack (1) produced according to claim 23, with five or a plurality of, in particular essentially rectangular layers for an electrochemical energy storage apparatus,
wherein the electrode stack (1) has two or a plurality of separator layers (2, 2a, 2b) and also three or a plurality of electrode plates (3, 3a, 4, 4a),
wherein the layers of the electrode stack (1) are essentially congruent, and
wherein one or a plurality of separator layers (2, 2a, 2b) are arranged between two adjacent electrode plates (3, 3a, 4, 4a) of different polarity in each case, wherein
these two or plurality of separator layers (2, 2a, 2b) extend in certain areas over adjacent electrode plates (3, 3a, 4, 4a) in each case, and
in that these two or plurality of separator layers (2, 2a, 2b) are constructed integrally.

25. The electrode stack (1) according to claim 23, wherein the one or plurality of separator layers (2, 2a, 2b) are not or only poorly electron conductive and consist(s) of a substrate which is at least partially permeable to material,
wherein the substrate is preferably coated on at least one side with an inorganic material,
wherein an organic material, which is preferably configured as a non-woven fleece, is preferably used as a substrate which is at least partially permeable to material,
wherein the organic material preferably comprises a polymer and particularly preferably polyethylene terephthalate (PET),
wherein the organic material is coated with an inorganic, preferably ion-conducting material which is further preferably ion-conducting in a temperature range from −40° C. to 200° C.,
wherein the inorganic material preferably comprises at least one compound from the group of oxides, phosphates, sulphates, titanates, silicates, aluminosilicates of at least one of the elements Zr, Al, Li, particularly preferably zirconium oxide, and
wherein the inorganic ion-conducting material preferably has particles with a largest diameter below 100 nm.

26. The electrode stack (1) according to claim 25, wherein at least one electrode plate (3, 3a, 4, 4a), in particular at least one cathodic electrode plate has a compound with the formula LiMPO4,
wherein M is at least one transition metal cation of the first row of the periodic table of the elements,
wherein the transition metal cation is preferably chosen from the group consisting of Mn, Fe, Ni and Ti or a combination of these elements, and
wherein the compound has an olivine structure.

27. An electrochemical energy storage apparatus with one or a plurality of electrode stacks (1) according to claim 26 and a jacket which surrounds the one or plurality of electrode stacks (1).

28. A battery with two or a plurality of the electrochemical energy storage apparatuses according to claim 27.
